(19) United States
(12) Patent Application Publication
(10) Pub. No.: US 2009/0246441 A1
(43) Pub. Date: Oct. 1, 2009

(54) System and Method for Photobleaching of Optical Media

(75) Inventors: Kwok Pong Chan, Troy, NY (US); David Gilles Gascoyne, Niskayuna, NY (US); Marc Brian Wisnudel, Clifton Park, NY (US); Kasiraman Krishnan, Clifton Park, NY (US)

Correspondence Address: GENERAL ELECTRIC COMPANY (PCPI);C/O FLETCHER YODER, P. O. BOX 692289, HOUSTON, TX, 77269-2289, US

(73) Assignee: NBC Universal, Inc., New York, NY (US)

(21) Appl. No.: 12/059,943

(22) Filed: Mar. 31, 2008

(51) Int. Cl. B32B 3/02; C09D 11/00; B05D 5/06; B32B 9/04

(52) U.S. Cl. 428/64.4; 106/31.13; 106/31.27; 524/570; 524/556; 524/551; 524/588; 524/599; 524/592; 428/195.1; 428/688; 428/704; 427/162

(57) ABSTRACT

A photobleachable ink composition having: at least one light-sensitive optical-state change material; at least one bleaching agent; at least one ionic liquid plasticizer; at least one solvent; and at least one binder material; wherein the ink composition has a viscosity between about 0.1 centipoise and about 10,000 centipoise, and a maximum optical absorbance in a range from about 200 nanometers to about 800 nanometers; and wherein said ink composition is capable of change from a first optical state to a second optical state upon exposure to light.

### BACKGROUND

The present invention relates generally to optical storage devices, such as DVDs and CDs. More specifically, the invention provides optical storage devices on which compositions containing dyes are disposed for facilitating limited or selective use of at least a portion of the content of the optical storage devices.

Portable optical storage devices such as CDs and DVDs have attained a large consumer market in recent years. As such, there has been much effort to improve the technology and for companies to gain a competitive advantage. Along that vein, recently ways have been sought to modify or limit the content, such as by providing limited-play content, to prevent unauthorized copying of the content stored on these devices, and so on. Such issues have been addressed via the use of dye, phase-change, and other chemical compounds that change their molecular state when irradiated with light.

There is an on-going need to develop an optical storage device, and a method for making it, containing a dye that changes optical properties relatively quickly, that does so under only a few repeated exposures to relatively low intensity energy, that does so at approximately the same wavelength as the energy applied, that does not introduce significant errors to the storage device by its addition thereto.

### BRIEF DESCRIPTION

In one embodiment, the present technique provides for a photobleachable ink composition including: at least one light-sensitive optical-state change material; at least one bleaching accelerant; at least one ionic liquid plasticizer; at least one solvent; and at least one binder material; wherein the ink composition has a viscosity between about 0.1 centipoise and about 10,000 centipoise, and a maximum optical absorbance in a range from about 200 nanometers to about 800 nanometers; and wherein said ink composition is capable of change from a first optical state to a second optical state upon exposure to light.

In one embodiment, the present technique includes a photosensitive ink composition, having: at least one photosensitive optical-state change material comprising a dye; at least one additive for accelerating bleaching; at least one ionic liquid plasticizer; at least one solvent; and at least one binder material, wherein the phtosensitive ink composition comprises a viscosity between about 0.1 centipoise and about 10,000 centipoise, and a maximum optical absorbance in a range from about 200 nanometers to about 800 nanometers, and wherein the phtosensitive ink composition is capable of transforming from a first optical state to a second optical state upon exposure to an optical stimulus.

In one embodiment, the present technique includes a light-sensitive coating deposited using a light-sensitive ink composition, wherein the coating has: at least one light-sensitive optical-state change material; at least one bleaching agent; at least one ionic liquid plasticzer; and at least one binder material, wherein the light-sensitive coating is essentially free of solvent and has a maximum optical absorbance in a range from about 200 nanometers to about 800 nanometers, and wherein the light-sensitive coating is capable of transforming from a first optical state to a second optical state upon exposure to light.

In one embodiment, the present technique provides for an article having a photosensitive coating composition deposited in or deposited on the article, wherein the photosensitive coating composition comprises at least one photosensitive optical-state change material, at least one additive for accelerating the bleaching, at least one ionic liquid plasticzer, and at least one binder material, wherein said photosensitive coating composition is essentially free of solvent, wherein said photosensitive coating composition has an optical absorbance in a range from about 200 nanometers to about 800 nanometers, and wherein said photosensitive coating is capable of transforming from a first optical state to a second optical state upon exposure to a light stimulus.

In one embodiment, the present technique includes an optical storage device on which at least some limited-use data is stored, the device having: a storage layer for storing data readable by an optical storage device data reader system; a content access layer covering at least a portion of the data stored on the storage layer and comprising an ink composition comprising a dye compound and an ionic liquid plasticzer, wherein the ink composition exhibits a measurable change in optical properties in less than about 10 seconds of exposure to a light source emitting wavelengths from about 635 nm to about 650 nm at an intensity from about 1 mW to about 50 mW; and an optically transparent layer through which stored data from the storage layer is accessible.

In one embodiment, the present technique provides for an optical storage device, on which at least some limited-use data is stored, the device including: a storage layer for storing data readable by an optical storage device data reader system; a content access layer covering at least a portion of the data stored on the storage layer, wherein the content access layer comprises a dye, a bleaching accelerant, and an ionic liquid plasticzer, wherein the dye exhibits a measurable change in optical properties upon sufficient exposure to one or more characteristic wavelengths of energy; and an optically transparent layer through which stored data from the storage layer is accessible.

In one embodiment, the present technique provides a method of fabricating a limited-use optical storage device, the method including: depositing a photobleachable ink composition comprising at least one light-sensitive optical-state change material, at least one bleaching agent, at least one ionic liquid plasticzer, at least one solvent, and at least one binder material; wherein the ink composition has a viscosity between about 0.1 centipoise and about 10,000 centipoise, and a maximum optical absorbance in a range from about 200 nanometers to about 800 nanometers, and wherein the ink composition is capable of transforming from a first optical state to a second optical state upon exposure to light.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-section perspective of an optical storage device in which a content access layer and an optically transparent layer are added to a pre-fabricated optical storage device in accordance with embodiments of the present technique;

FIG. 2 is a cross-section perspective of an optical storage device in which a content access layer is places between a storage layer and an optically transparent layer in accordance with embodiments of the present technique;

FIG. 3 is a cross-section perspective of an optical storage device having first and second storage layers, in which a content access layer is disposed between the first storage layer and the external surface of the optical storage device that is to be exposed to energy from an optical data reader in accordance with embodiments of the present techniques;

FIG. 4 is a top view perspective of a DVD, as in FIG. 1, where the content access layer is spin-coated onto the pre-fabricated DVD, and a mask was used to photobleach spots on the content access layer in accordance with embodiments of the present technique;

FIG. 5 is a flow chart of a method of fabricating an optical storage device, such as those depicted in FIGS. 1 and 4, in accordance with embodiments of the present technique; and

FIG. 6 is a flow chart of a method of fabricating an optical storage device, such as the device depicted in FIG. 2, in accordance with embodiments of the present technique.

### DETAILED DESCRIPTION

While only certain features of the invention have been illustrated and described herein, many modifications and changes will occur to those skilled in the art. It is, therefore, to be understood that the appended claims are intended to cover all such modifications and changes as fall within the true spirit of the invention.

Embodiments of the present technique incorporate a polymethine dye (e.g., cyanine dye), either alone or in an ionic compound in which the anion is an additive for accelerating bleaching, such as an alkylphenyl substituted borate anion. The additive for accelerating bleaching (which may also be labeled as bleaching agent, bleaching accelerant, etc.) generally may be an electron donating agent (e.g. amine, borate). Beneficially, exemplary cyanine/borate systems generally bleached much faster than xanthene dye-based systems or systems in which the anion associated with the cyanine cation is not an additive for accelerating bleaching, for example.

Embodiments of the present invention incorporate an additive for accelerating bleaching and an ionic liquid plasticizer combined together into the same ionic compound. For example the cation of an ionic liquid plasticizer can be combined with the anion of an agent for accelerating bleaching to produce a compound that is both an ionic liquid plasticizer and an agent for accelerating bleaching. Beneficially exemplary ionic liquid plasticizer/bleaching accelerating systems that incorporate these two functions into a single ionic compound generally produce better films and bleach faster than systems that do not incorporate the ionic liquid plasticizer and bleaching accelerant into the same ionic compound.

To facilitate limited-play (e.g., one-play technology) to function effectively the speed of photobleaching should generally be below a certain threshold. In accordance with the present technique, the addition of one or more ionic liquid plasticizers to the ink formulation may increase the speed of the photobleaching so that the speed or rate is below a desired threshold (e.g., a threshold for one-play) and remains below this threshold for the lifetime of the product.

The present technique consists of a formulation of a photobleachable ink which contains a plasticizer, such as ionic liquid plasticizers (e.g., imidazolium salts, quaternary ammonium salts, phosphonium salts, pyrazolium salts, pyridinium salts, sulfonium salts, piperidinium salts, morpholinium salts). The use of ionic liquid plasticizers increases the speed with which the ink photo bleaches when exposed to 630-660 nm light. The present formulations may include a photobleachable ink containing BR₁R₂R₃R₄ where R₁, R₂, R₃, and R₄ independently represent an alkyl, aryl, alkaryl, allyl, alkenyl, alkynyl, heterocyclic, substituted alkyl, or substituted aryl group as a photobleaching agent. Advantageously, an ionic liquid plasticizer generally provides for low volatility compared to traditional plasticizers, such as esters of phthalic acid or adipates. Because of this low volatility, the ionic liquid plasticizer will typically remain in the printed ink for a longer period of time than the traditional plasticizer. Therefore, ionic liquid plasticized inks will generally have better performance over time than employing traditional plasticizers. Furthermore, embodiments provide for new ionic liquids that can act both as a plasticizer and bleaching accelerant (i.e., photo-bleaching agent, bleaching agent, etc.).

The current ink formulation may be used to print spots on the data side of DVD such that DVD laser would not be able to read information underneath the printed spots. At the same time, the ink will undergo photobleaching when it comes into contact with the DVD laser. This light exposure causes the printed spot to become transparent to the DVD laser. Embodiments formulate an ink that photobleaches with brief exposure to a laser of relatively low power (e.g. the laser on an optical head in a DVD drive or DVD player).

An ink formulation containing organic plasticizers, such as esters of phthalic acid (e.g. dioctyl phthalate) may provide for a faster bleach rate than the un-plasticized one. However, the bleach rate of dioctyl phthalate plasticized ink generally decreases over time presumably because the printed ink loses dioctylphthalate through evaporation. This degradation of performance over time decreases the reliability of the product. Therefore, the new ionic liquid plasticizers (e.g., imidazolium salts, quaternary ammonium salts, phosphonium salts, pyrazolium salts, pyridinium salts, sulfonium salts, piperidinium salts, and morpholinium salts) may be beneficial in they typically evaporate slower than esters of phthalic acid like dioctyl phthalate. Further, the present technique includes ionic compounds which combine the cationic portion of an ionic liquid with the anionic portion of a bleaching agent to form a dual purpose ionic liquid plasticizer/bleaching agent in the same compound. Further, the present technique includes solvent compositions that can dissolve most or all of the ink components. Also, the solvent compositions are generally compatible with the printing processes used to apply the ink to the polycarbonate DVD substrate.

It should be noted that the bleach rate is given as an index, as compared to a value of 1 for a control formulation of 2.6 wt % HNu640 Dye, 5 wt % Borate V (butyrylcholine triphenyl-n-butyl borate), 5 wt % polymethylmethacrylate (PMMA), and balance solvent. Evaluation of bleach rate may involve monitoring the color and/or reflectivity of the deposited ink composition over time. In these examples, the bleach rate is the rate of change in reflectivity over time, monitored at 650 nm. For the control formulation, the index of 1 is a value of 0.13 delta % reflectivity per second. Delta % reflectivity is defined as the difference in % reflectivity of the optical article before and after the light-sensitive coating is exposed to light.

In the final commercial form, the photobleachable ink will be applied to a DVD that is authored to play certain video content when the ink is in its dark blue “unbleached” state but skip over the content when the ink is in its bleached state. The ink will get bleached during the first play of the DVD so the 1-play content will only be viewable the first time the DVD is played. The present technique includes ink compositions for relatively fast photobleaching ink, and to facilitating the 1-play DVD technology, for example. This technology may create new revenue stream for 1-play trailers and advertisements on DVDs, for example. The alternative approach of designing hardware changes into DVD players to promote 1-play may be problematic because it would not address the legacy players that consumers already have in their homes. In contrast, with the present technique including increased speed of bleaching in a plasticized ink matrix, the one-play may function on legacy players. It should be emphasized that while the present discussion may at times focus on limited-play DVDs, the present technique is applicable optical articles, in general, and for a variety of applications other than limited-play.

In general, the present limited-play ink compositions may include at least one photosensitive optical-state change material, at least one additive for accelerating the bleaching (which may also be labeled bleaching agent, bleaching accelerant, etc.), at least one solvent, and at least one binder material. The composition may have a viscosity between about 0.1 cPs and about 10,000 cps, which may facilitate the printing of the ink on the DVD. The compositions may have a maximum optical absorbance in a range from about 200 nm to about 800 nm, and when exposed to an optical stimulus having light of such a range, the photosensitive ink composition (which may also be labeled light-sensitive ink composition, for example) is capable of transforming from a first optical state to a second optical state.

The term “photosensitive” as used herein, describes materials that undergo either a reversible or an irreversible light induced color change. As used herein the term “optical-state change” material is used to describe a material which is capable of existing in at least two different forms, each form possessing a unique optical state, for example a unique wavelength associated with a maximum optical absorbance within a range from about 200 nm to about 800 nm, or a unique extinction coefficient at a specific wavelength between about 200 nm to about 800 nm. Non-limiting examples of photosensitive optical-state change materials include various dyes and pigments that respond to different wavelengths of light.

In various embodiments, the solvents used in the photosensitive ink compositions are selected based on different parameters as discussed herein. For example, a suitable solvent may be selected to satisfy the solubility of various components in the photosensitive ink composition including the binder material, the photosensitive optical-state change material, and the additive for accelerating the bleaching. In other examples, wherein the photosensitive ink composition is used to deposit a photosensitive coating composition, the solubility of the different components of the photosensitive ink composition in the solvent should be such that there will be no phase separation of the different components during the post-deposition drying step.

In other instances, where the photosensitive ink composition is used to deposit a photosensitive coating composition on an article, applicable solvents may include those that exhibit a chemical inertness towards the material used to form the article. For example if the article is an optical article such as for example a DVD made using a polycarbonate, the selected solvent(s) should not induce problematic solubilization, crystallization, or any other form of chemical or physical attack of the polycarbonate. This is beneficial to preserve the readability of the data underneath the photosensitive coating composition. In the case of solvent mixtures, the volume fraction of any solvent that could potentially attack the polycarbonate may be less than about 50 percent. As used herein the term “surface tension” refers to a property of the liquid that affects the spreading of a liquid on a surface. The surface tension will have a dramatic result on the final shape of a drop or multiple drops of liquid printed on solid surfaces. With respect to the ink formulations of the present disclosure, surface tension may be an important (or even critical) parameter for printing the ink formulations using conventional printing techniques such as inkjet printing, screen printing, and so on. Surface tension is also a parameter for the jetting process itself during inkjet printing, as it will affect how drops are formed at the print-head. If the surface tension is not appropriate, inks will not be jettable with inkjet printing.

Other aspects of the present solvents may include low vapor pressure and high boiling points, such that the photosensitive ink is printable by methods known to one skilled in the art (e.g., screen printing or ink-jet printing techniques). Unfortunately, solvents with lower boiling points may evaporate rapidly from the ink, causing clogging of inkjet print head nozzles or drying onto a printing screen, either of which can lead to poor quality of the resultant photosensitive coating. Thus, solvents presently employed may have a boiling point above 130° C. is preferred. In various embodiments, in general, the photosensitive ink composition should be a physical mixture of the various components and there should be no reactivity between the components at least under ambient conditions.

Solvents employed in the photosensitive ink composition may include, but are not limited to: a glycol ether solvent, an aromatic hydrocarbon solvent containing at least 7 carbon atoms, an aliphatic hydrocarbon solvent containing at least 6 carbon atoms, a halogenated solvent, an amine based solvent, an amide based solvent, an oxygenated hydrocarbon solvent, or miscible combinations thereof. Some specific non-limiting examples of such solvents include diacetone alcohol, dipropylene glycol methyl ether (Dowanol DPM), butyl carbitol, ethylene glycol, glycerol with glycol ethers, cyclohexanone, or any miscible combinations thereof.

A function of the binder materials is to assist the adherence of a photosensitive ink composition to the surface of an article on which the photosensitive ink composition is deposited. Suitable non-limiting examples of binder materials include one or more of a polymer, an oligomer, a polymeric precursor, and a polymerizable monomer. Suitable non-limiting examples of polymeric materials include poly(alkenes), poly(anilines), poly(thiophenes), poly(pyrroles), poly(acetylenes), poly(dienes), poly(acrylates), poly(methacrylates), poly(vinyl ethers), poly(vinyl thioethers), poly(vinyl alcohols), poly(vinyl ketones), poly(vinyl halides), poly(vinyl nitriles), poly(vinyl esters), poly(styrenes), poly(arylenes), poly(oxides), poly(carbonates), poly(esters), poly(anhydrides), poly(urethanes), poly(sulfonates), poly(siloxanes), poly(sulfides), poly(thioesters), poly(sulfones), poly(sulfonamides), poly(amides), poly(ureas), poly(phosphazenes), poly(silanes), poly(silazanes), poly(benzoxazoles), poly(oxadiazoles), poly(benzothiazinophenothiazines), poly(benzothiazoles), poly(pyrazinoquinoxalines), poly(pyromellitimides), poly(quinoxalines), poly(benzimidazoles), poly(oxindoles), poly(oxoisoindolines), poly(dioxoisoindolines), poly(triazines), poly(pyridazines), poly(piperazines), poly(pyridines), poly(piperidines), poly(triazoles), poly(pyrazoles), poly(pyrrolidines), poly(carboranes), poly(oxabicyclononanes), poly(dibenzofurans), poly(phthalides), poly(acetals), poly(anhydrides), carbohydrates, blends of the above polymeric materials, and copolymers thereof. In one embodiment, the photosensitive ink composition comprises a polymerizable monomer, such as an acrylate monomer (e.g., methyl methacrylate), which can be polymerized (i.e. cured) to form a photosensitive coating after the photosensitive ink composition has been deposited on an optical article.

As described herein, the term “photosensitive ink composition” is used to describe a liquid composition comprising various components as described above. In one embodiment, the photosensitive ink composition has a viscosity in a range from about 0.1 cPs to about 10,000 cps. In another embodiment, the ink composition has a viscosity in a range from about 5 cPs to about 200 cPs. In yet another embodiment, the ink composition has a viscosity in a range from about 5 to 15 cPs and in yet another embodiment, the ink composition has a viscosity in a range from about 35 to about 120 cPs. In various embodiments, the viscosity of the photosensitive ink composition may be tuned by controlling the concentration, such as for example the weight percent of the various components of the photosensitive ink composition, and/or by carefully controlling a particular property of a specific component of the photosensitive ink composition such as for example the molecular weight of the binder material.

In one embodiment, the difference in the optical absorption of the ink composition between the first optical state and the second optical state is at least 10 percent. In yet another embodiment, the difference in the percent transmittance of the photosensitive optical-state change material between the first optical state and the second optical state is at least 10 percent.

In one example, the photosensitive ink composition has a maximum optical absorbance in a range of about 200 nm to about 800 nm. In another embodiment, the photosensitive ink composition has a maximum optical absorbance in a range of about 300 nm to about 700 nm. In yet another embodiment, the photosensitive ink composition has a maximum optical absorbance in a range of about 400 nm to about 660 nm. It will be appreciated that the specific wavelengths for which the absorbance of the composition is maximized may be chosen to correspond to a particular application. For instance, if the composition is intended for use with DVD systems, the choice of wavelength should desirably correspond to the wavelengths in use in DVD players.

The present technique may provide a photosensitive coating composition, deposited using a photosensitive ink composition, wherein the photosensitive coating composition has at least one photosensitive optical-state change material, at least one additive for accelerating the bleaching, and at least one binder material, wherein the photosensitive coating composition is essentially free of solvent, wherein the photosensitive coating composition has a maximum optical absorbance in a range from about 200 nm to about 800 nanometers, and wherein the photosensitive coating composition is capable of transforming from a first optical state to a second optical state upon exposure to an optical stimulus. In yet another embodiment, the present technique provides an article having a photosensitive coating composition deposited in or deposited on the article.

As used herein, the term “coating” describes a layered film structure. In certain embodiments, the layered film structure may comprise a single layer. In one embodiment, the thickness of the coating is in a range from about 0.1 micron to about 100 microns. In another embodiment, the thickness of the coating is in a range from about 0.1 micron to about 1.0 microns. In yet another embodiment, the thickness of the coating is in a range from about 0.2 micron to about 0.6 microns.

In one embodiment, the photosensitive coating composition may be deposited on an article using the photosensitive ink composition by employing methods known to one skilled in the art. For example, screen printing and inkjet printing methods can be used. In one embodiment, the article is an optical article. Subsequent to printing, the photosensitive ink composition may be converted to the corresponding photosensitive coating composition through an additional drying step, using methods known to one skilled in the art. Exemplary methods include air drying at ambient conditions, drying under controlled temperature conditions such as for example in an oven, drying under vacuum, and the like.

As used herein, the term “essentially free of solvent” means that the photosensitive coating composition may contain less than about 0.1 weight percent of solvent based on the total weight of the photosensitive coating composition.

In various embodiments for photosensitive coating composition, the photosensitive optical-state change material, the additive for accelerating the bleaching, the binder material, may be the same or similar to those discussed above for the photosensitive ink composition.

In one embodiment, the photosensitive coating composition has a maximum optical absorbance in a range of about 200 nm to about 800 nm. In another embodiment, the photosensitive coating composition has a maximum optical absorbance in a range of about 300 nm to about 700 nm. In yet another embodiment, the photosensitive coating composition has a maximum optical absorbance in a range of about 400 nm to about 660 nm. As discussed above, it will be appreciated that the specific wavelengths for which the absorbance of the composition is maximized may be chosen to correspond to a particular application.

As used herein, the term “optical article” refers to an article that includes an optical data layer for storing data. The stored data may be read by, for example, an incident laser of an optical data reader device such as a standard compact disc (CD) or digital versatile disc (DVD) drive, commonly found in most computers and home entertainment systems. In some embodiments, the optical article may include one or more data layers. Furthermore, the optical data layer may be protected by employing an outer coating, which is transparent to the incident laser light, and therefore allows the incident laser light to pass through the outer coating and reach the optical data layer. Non-limiting examples of optical articles include: a compact disc (CD); a digital versatile disc (DVD); multi-layered structures, such as DVD-5 or DVD-9; multi-sided structures, such as DVD-10 or DVD-18; a high definition digital versatile disc (HD-DVD); a Blu-ray disc; a near field optical storage disc; a holographic storage medium; and a volumetric optical storage medium, such as, a multi-photon absorption storage format.

In one embodiment, when the photosensitive ink composition or the photosensitive coating composition is in the first optical state the optical article may be considered to be in a pre-activated state of functionality and when the photosensitive ink composition or the photosensitive coating composition is in the second optical state the optical article may be considered to be in an activated state of functionality. In one embodiment, the difference in the percent optical reflectivity or the percent transmittance of at least one portion of the optical data layer in the “pre-activated state” of functionality and the “activated” state of functionality is at least about 10 percent. In another embodiment, the difference in the percent optical reflectivity or the percent transmittance of at least one portion of the optical data layer in the “pre-activated state” of functionality and the “activated” state of functionality is at least about 25 percent. In yet another embodiment, the difference in the percent optical reflectivity or the percent transmittance of at least one portion of the optical data layer in the “pre-activated state” of functionality and the “activated” state of functionality is at least about 50 percent.

In various embodiments, the optical article comprising the photosensitive coating composition may be transformed from a “pre-activated” state of functionality to an “activated” state of functionality. Conversion from the “pre-activated” state of functionality to the “activated” state of functionality is achieved by the activation of the photosensitive coating composition, which is deposited in or on the optical article, such that the photosensitive coating composition is in optical communication with the optical data layer. As used herein, the term optical communication refers to transmission and reception of light by optical devices. The photosensitive coating composition is activated by interacting with one or more thermal stimuli, applied either directly or remotely to the photosensitive coating composition. In one embodiment, the photosensitive coating composition is capable of irreversibly altering the state of functionality of the optical article. In the “pre-activated” state, at least one portion of the data from the optical data layer is unreadable by the incident laser of an optical data reader device, however, this same portion of data can be read from the optical data layer in the “activated” state of functionality.

As used herein, the term “pre-activated” state of functionality refers to a state of functionality of the optical article where the photosensitive coating composition has not yet been exposed to one or more external stimuli, while the “activated” state refers to a state of functionality where the photosensitive coating composition has been exposed to the external stimuli.

In certain examples, the pre-activated and activated states are linked with an “authoring” component on the DVD, which allows the disc to play the trailer or not play the trailer, depending on whether portions of the data on the optical data layer can be read by the incident laser from an optical data reader. An explanation of the term “authoring” as it relates to an optical article, such as a DVD, can be found in “DVD Authoring and Production”, by Ralph LaBarge, CMP Books, 2001. In this second approach, the photosensitive coating composition is at least partially opaque to the incident laser from an optical data reader in the “pre-activated” state, and the data directly in the optical path of the laser cannot be read. In this instance, the optical article is “authored” to play the trailer. Upon converting the optical article to the “activated” state using an external stimulus, the photosensitive coating is at least partially transparent to the incident laser, the data directly in the optical path of the laser can be read, and the disc is “authored” to skip the trailer and directly go to the menu.

Alternatively, instead of being deposited on the surface of the optical article, the photosensitive coating composition may be deposited inside the structure of the optical article. In optical storage articles, the photosensitive coating composition may be deposited in the substrate on which the optical data layer is deposited. In such an embodiment, the photosensitive coating composition may be mixed with the substrate material of the optical article. In alternate embodiments, the photosensitive coating composition may be deposited between the layers of the optical article, or may be deposited within the layers of the optical article. For example, the photosensitive coating composition may be incorporated in the UV curable adhesive of the bonding (spacer) layer. Also, these photosensitive coating compositions may preferably absorb the wavelength of the laser in one of the activated, or the pre-activated state of the optical article. Upon interaction with external stimulus, the photosensitive coating composition present inside the substrate changes color. As a result, the substrate may become transparent to the laser light, thereby facilitating the transmittance of laser light through the substrate.

In some embodiments, at least a portion of the photosensitive coating composition is coated with an optically transparent second layer. The optically transparent second layer serves as a protective coating for the photosensitive coating composition from chemical and/or physical damage. The optically transparent second layer may contain cross-linkable materials that can be cured using ultraviolet (UV) light or heat. Furthermore, the optically transparent second layer may be a scratch resistant coating. For example, the optically transparent second layer may include, but is not limited to, a matrix consisting of cross-linkable acrylates, silicones, and nano or micron silicate particles. Suitable examples of an optically transparent second layer can be found in U.S. Pat. No. 5,990,188.

Optical storage devices, as described herein, are typically those that store information capable of being accessed using optical data reader systems including light sources such as visible lasers, UV lasers, infrared lasers, or the like, and detectors therefof. As used herein, the term “optical”, with reference to optical storage devices and optical data reader systems, means that the information stored thereon and/or retrieved thereby utilizes wavelengths from about 100 nm to about 1 micron, preferably from about 200 nm to about 850 nm. In certain embodiments, the term “optical” refers to wavelengths of light that is visible to the human eye, or those from about 370 nm to about 800 nm.

While the optical storage devices described herein generally involve optical storage and are typically in read-only format, the invention is not limited thereto, as, e.g., writable and/or re-writable format optical storage devices may also be used. Examples of optical storage devices, as described herein, can include, but are not limited to, DVDs such as DVD-5, DVD-9, DVD-10, DVD-14, and DVD-18, CDs, laser discs, HD-DVDs, Blu-ray discs, magneto-optical, UMD, volumetric storage media such as holographic media and the like, including pre-recorded, recordable, and rewriteable versions of such formats.

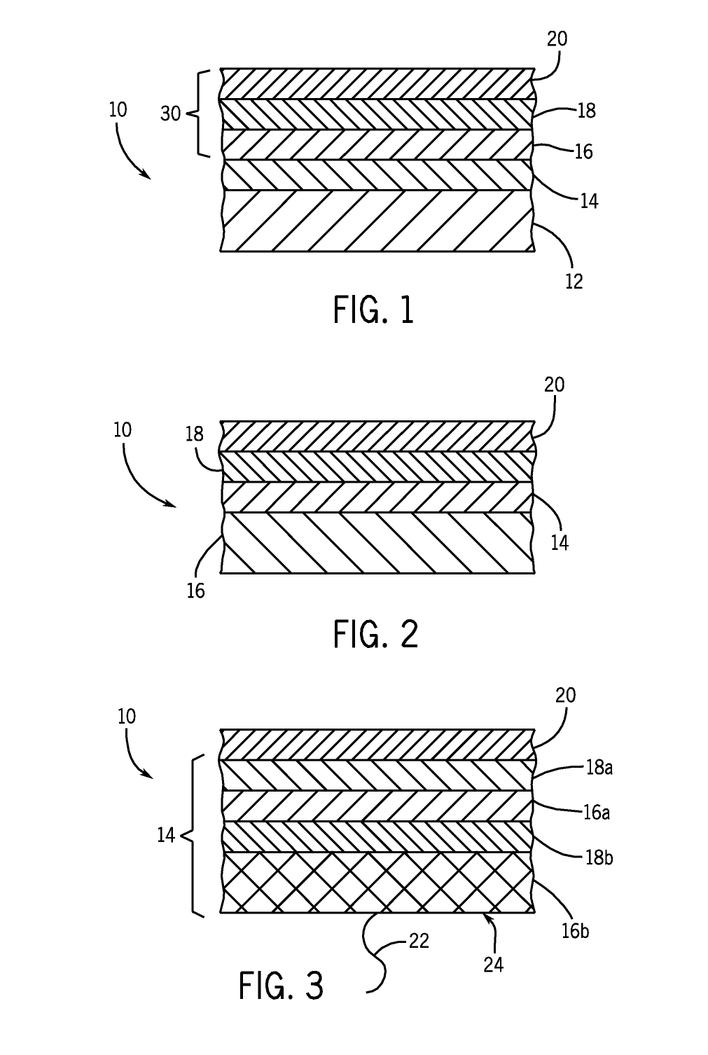

Storage layers, such as storage layer 18 (FIG. 1), in most optical storage devices are relatively consistent. For instance, in CDs and DVDs, a reflective layer is the storage layer and typically includes a series of bumps/pits that correspond to data. This data can be read by data reader systems, e.g., optical readers, where a laser light of a given wavelength (e.g., about 405 nm for HD-DVD and Blu-ray discs, about 635-650 nm for DVDs, and about 780 nm for CDs) is reflected off the surface of the storage layer to a detector keyed to receive the given wavelength of light, for instance, as the storage device is rotated. The bumps reflect the light differently than the other portions of the storage layer, and the pattern of those different reflections of light encodes the stored data.

In the case of conventional CDs and DVDs, the storage layer typically contains or is made from a reflective metallic material like aluminum. As shown in FIG. 1, disposed on opposite sides of storage layer 18 are a first layer 20 (e.g., typically an acrylic resin and/or polycarbonate substrate) that primarily protects the storage layer and a second layer 16 (e.g., typically a polycarbonate) which is substantially transparent to the given wavelength of light and thus through which the light from the optical reader is applied and reflected, and which can also function as another protective layer for storage layer 18. In some cases, there can be multiple storage layers on a single side of the substrate, back-to-back storage layers, bonding/adhesive layers, and/or additional optically transparent layers. Collectively, first or coating layer 20, storage layer 18, and second or optically transparent layer 16, as shown in FIG. 1, can represent the structure a conventional single-sided CD or DVD (30).

As shown in FIGS. 1-2, content access layer 14 can be disposed anywhere on optical storage device 10 between storage layer 18 and the data reader system energy (light) source. For instance, in FIG. 2, content access layer 14 is disposed between storage layer 18 and optically transparent layer 16, while in FIG. 1 content access layer 14 is disposed between the data reader system energy source and optically transparent layer 16, or both. In one preferred embodiment, based on FIG. 1, content access layer 14 is disposed on optically transparent layer 16 and thus between optically transparent layer 16 and the data reader system energy source (not shown). In another preferred embodiment, shown in FIG. 1, content access layer 14 is disposed between optically transparent layer 16 (disposed on storage layer 18) and a second optically transparent layer 12 that is disposed on an outermost surface of optical storage device 10 and can function to protect content access layer 14.

One aspect of the invention, shown in FIG. 2, is an optical storage device (10), such as a CD or a DVD, on which at least some limited-use data is stored and comprising storage layer 18 on which data is stored, content access layer 14 covering at least a portion of the data stored on the storage layer, coating layer 20 capable of protecting the storage layer and thus the data thereon, and, optionally but preferably, an optically transparent layer (16) through which the stored data from the storage layer can be accessed. In most embodiments, optically transparent layer 16 also functions as a protective layer but is disposed on a side of storage layer 18 opposite from the side on which coating layer 20 is disposed. In one embodiment, content access layer 14 and optically transparent layer 16 are combined to form a single optically transparent content access layer.

In another embodiment, shown in FIG. 3, an optical storage device (10), such as a DVD-9, on which at least some limited-use data is stored and comprising two storage layers 18a, 18b on which data is stored, two optically transparent layers 16a, 16b through which the stored data from storage layers 18a, 18b can be accessed, coating layer 20 capable of protecting the storage layers and thus the data thereon, and content access layer 14 covering at least a portion of the data stored on at least one of the storage layers. Although content access layer 14 is shown in FIG. 3 to be disposed between storage layer 18b and optically transparent layer 16b, this is merely one embodiment. Content access layer 14 can be disposed anywhere in optical storage device 10 between storage layer 18a and the energy-incident surface 24 of the most external optically transparent layer 16b. Content access layer 14 can be its own layer or can be coterminous, co-formed, or mixed together with one or more of optically transparent layers 16a, 16b. Wavelengths of energy 22 from optical storage device data reader system (not shown) can be used to access the data stored on storage layers 18a, 18b, at least some of which data can be covered by content access layer 14.

Content access layer 14, as described herein, may include an ink composition, which includes, but is not limited to: one or more dye compounds that exhibit a change in optical properties (e.g., photobleaching) upon exposure for a sufficient time and at a sufficient intensity to one or more wavelengths of energy (light) typically emitted by optical storage device data reader systems discussed above; a diluent/solvent; an oligomeric/polymeric binder/viscosity enhancer; optionally an bleaching accelerant for the dye compound (e.g., an electron donor, a dye compound bleaching activator, or the like, or a combination thereof); and other optional components known in the art, such as dispersants, salts, or the like, or combinations thereof.

The dye compound, as described herein, can be tailored to the specific wavelength of energy (light) typically emitted by the particular optical storage device data reader system; i.e., a dye compound for use on a DVD should exhibit a significant change in optical properties upon sufficient exposure to wavelengths of about 635-650 nm, while a dye compound for use on a HD-DVD or Blu-ray disc should exhibit a significant change in optical properties upon sufficient exposure to wavelengths of about 405 nm, and a dye compound for use on a CD should exhibit a significant change in optical properties upon sufficient exposure to wavelengths of about 780 nm. Examples of general classes of dye compounds meeting such requirements may include polymethines (e.g., cyanines), xanthenes, thiazines, oxazines, lactones, fulgides, spiropyrans, and diarylethenes. Examples of such dye compounds can include, but are not limited to, methylene blue, toluidine blue, Rose Bengal, erythrosine B, eosin Y, fluorone dyes, and those dyes and photoinitiators disclosed in U.S. Pat. Nos. 5,451,343 and 5,395,862, and in International Publication No. WO 97/21737.

In one embodiment, the dye compound contains a polymethine dye having the following generic formula:

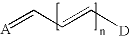

In another embodiment the dye compound contains a cyanine cation having the following generic formula:

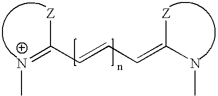

In another embodiment the dye compound contains a cyanine cation having the following formula:

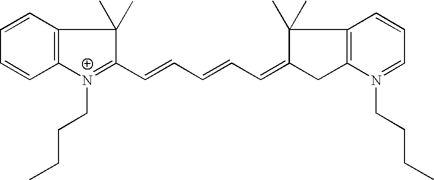

The change in optical properties of the dye compound/composition upon exposure to the energy source, e.g., from the optical data reader system for the particular optical storage device, can appear in any manner that results in the optical data reader system receiving a substantial change in the amount of energy detected. For example, where the dye is initially opaque and becomes more transparent upon exposure, there should be a substantial increase in the amount of light reflected off of the storage layer and transmitted through the content access layer and the optional optically transparent layer. Most dye compounds typically change (reduce) the amount of incident radiation detected by means of selective absorption at one or more given wavelengths of interest (corresponding to the type of optical storage device data reader system energy source). However, energy absorbance by the dye compound is not the only way to effect an optical property change.

Most types of optical storage device data reader system detectors are specifically designed to detect at least a certain intensity of radiation, reflected at a narrow set of wavelengths and/or frequencies surrounding the emitted wavelength(s) and/or frequency(ies), and usually in a particular polarization state. Therefore, besides absorbing the incident energy wavelength(s), the dye compound(s) and/or the ink composition may additionally or alternately accomplish any one or more of the following: change the polarization state of the incident energy; alter the frequency/wavelength of the incident energy; change the path of the incident energy, whether through reflection, refraction, scattering, or other means such that some portion of the energy is directed (and/or reflected off of the storage layer) away from the optical storage device data reader system detector.

For instance, in DVD-5 optical readers, the detector will typically read an error at least about 90% of the time when less than about 20% of the incident laser light reaches the detector, and the detector will typically read an error at least about 99% of the time when less than about 10% of the incident laser light reaches the detector. However, the detector will also typically read an error less than about 2% of the time when at least about 45% of the incident laser light reaches the detector. Thus, any dye compound/composition that can be alternated between these extremes of opacity and transparency at the given incident wavelength(s) upon exposure to energy of the same incident wavelength(s) is appropriate for use in content access layers, as described herein. Nevertheless, it is preferable to use dye compounds that are not threshold dye compounds for the incident energy wavelength(s). As used herein, “threshold dye compounds” mean dye compounds that do not exhibit a change in optical properties even upon repeated low-intensity exposure to incident energy at wavelength(s) typically emitted by conventional optical storage device data reader systems (e.g., from about 1 mW to about 10 mW for both CDs and DVDs). Without being bound to theory, it is believed that a threshold dye compound may experience desirable changes in optical properties upon exposure to incident energy of an intensity significantly higher (e.g., at least a factor of three higher, preferably at least a factor of five higher, and in some cases at least a factor of seven higher) than that emitted by current conventional optical storage device data reader systems at the given wavelength(s). As an example, the phthalocyanine and naphtholocyanine dyes disclosed in U.S. Patent Application Publication No. 2003/0081521 A1 are such threshold dyes, requiring an exposure at about 650 nm of more than 50 mW in intensity in order to bleach, and even then, those materials have been found instead to absorb energy at different wavelengths (on the order of about 700 nm, instead of the wavelength, about 650 nm, to which they were exposed).

The relative amount of dye compound in the ink composition of the content access layer will generally depend, at least in part, upon the initial opacity/color of the dye compound, the extent to which the dye compound changes optical properties (e.g., transparency/reflectivity) upon exposure to energy, and/or the thickness of the content access layer. In one embodiment, the ink composition can contain one or more dye compounds in a total amount ranging from about 0.01% to about 10% by weight, from about 0.1% to about 6% by weight, or from about 0.5% to about 5% by weight, for example from about 0.2% to about 3% by weight. In an alternate embodiment, the ink composition can contain one or more dye compounds in a total amount ranging from about 0.5 wt % to about 8%. In another alternate embodiment, the ink composition can contain one or more dye compounds in a total amount ranging from about 0.05% to about 0.5% by weight.

The use of an optional bleaching accelerant for the dye compound is generally beneficial, e.g., to decrease the applied energy intensity and/or exposure time necessary to effect the change in optical properties of the dye compound. Optical dye activators used in the content access layers, as described herein, can be tailored to the particular dye compound and/or ink composition. Examples of bleaching accelerants, as described herein, may include, but are not limited to, trifunctional amines such as triethanolamine, triethanolamine triacetate, N,N-dimethylethylamine (DMEA), N,N-dialkylanilines such as N,N-dibutylaniline and DIDMA (N,N-dimethyl-2,6-diisopropylaniline), ethyl-para-(dimethylamino)benzoate, octyl-para-(dimethylamino)benzoate, 4-diethylamino-o-tolualdehyde, ETQC (3-[(1-ethyl-1,2,3,4-tetrahydro-6-quinolinyl)methylene]-2,3-dihydro-4H-1-benzopyran-4-one), DEAW (2,5-bis[[4-(diethylamino)phenyl]methylene]-(2E,5E)-cyclopentanone), 4,4′,4″-methylidynetris[N,N diethyl-3-methyl-benzenamine], and the like, and combinations thereof; difunctional amines such as diethanolamine, n-phenylglycine, lophine monomer (2,4,5-triphenyl-1,3-imidazole) or dimer, 2-mercaptobenzoxazole, and the like, and combinations thereof; monofunctional amines such as ethanolamine, aniline, and the like, and combinations thereof; photoinitiators such as 1,4,4-trimethyl-2,3-diazabicyclo[3.2.2]non-2-ene-2,3-dioxide; acrylate (polyester) amines such as those sold under the tradename EBECRYL™; borate; Borate V (butyrylcholine triphenyl-n-butyl borate); borate salts such as n-butyrylcholine triphenyl-n-butyl borate, tetramethylammonium triphenylbutyl borate, tetramethylammonium trianisylbutyl borate, tetramethylammonium trianisyloctyl borate, and the like, and combinations thereof; iodonium salts such as OPPI ([4-(octyloxy)phenyl]phenyl-iodonium hexafluoroantimonate), bis(4-tert-butylphenyl)-iodonium triflate, (4-methoxyphenyl)-phenyliodonium triflate, (4-methylphenyl)-phenylidonium triflate, DDPI (dodecyldiphenyliodonium hexafluoroantimonate), (4-(2-tetradecanol)-oxyphenyl)iodonium hexafluoroantimonate, and the like, and combinations thereof; and the like; reaction/decomposition products thereof; and combinations thereof. Other useful bleaching accelerants can include, e.g., those disclosed in U.S. Pat. Nos. 5,451,343 and 5,166,041, as well as U.S. Patent Application Publication No. 2004/0152017 A1, the disclosures of each of which are hereby incorporated by reference.

When present, the relative amount of bleaching accelerant in the content access layer will generally depend, at least in part, upon the chemical nature of the dye compound, the relative amount of the dye compound, the initial opacity/color of the dye compound, the thickness of the content access layer, and/or the extent to which, and/or the speed with which, the dye compound changes transparency/reflectivity upon exposure to energy. In one embodiment, the content access layer contains one or more bleaching accelerants in a total amount ranging from about 0.1% to about 35% by weight, preferably from about 0.5% to about 25% by weight, more preferably from about 1% to about 15% by weight, for example from about 0.5% to about 9% by weight. In an alternate embodiment, the content access layer contains one or more bleaching accelerants in a total amount ranging from about 3% to about 12% by weight, preferably from about 2.5% to about 10% by weight. In another embodiment, the content access layer contains one or more bleaching accelerants such that the weight ratio of bleaching accelerants to dye compounds ranges from about 10:1 to about 1:10, preferably from about 10:1 to about 1:1, more preferably from about 8:1 to about 3:1.

In one example, the content access layer may contain one or more dyes or pigments as a colorant in addition to the ink composition. In this case, the color of these dyes or pigments may remain as the ink composition is bleached by exposure to the drive laser.

As with the optional bleaching accelerants, the optional oligomeric/polymeric binder/viscosity enhancer(s), as described herein, can be tailored to the particular ink composition used in the content access layer. Examples of oligomeric/polymeric binder/viscosity enhancers can include, but are not limited to, polyacrylates such as oligomeric methyl methacrylates (e.g., Elvacite® 2008, commercially available from Lucite), poly(methyl methacrylate)s and/or ammonio methacrylates (e.g., those polymers and copolymers sold under the tradename EUDRAGIT®), poly(alkyl acrylate)s such as poly(methyl acrylate), poly(alkacrylate)s, poly(alkyl alkacrylate)s such as poly(ethyl methacrylate), poly(hydroxyalkyl acrylate)s, poly(hydroxyalkyl alkacrylates such as poly(2-hyroxyethyl methacrylate), and the like; poly(vinyl alcohol) and/or oligomeric vinyl alcohols; styrenics, including polystyrene, poly(hydroxystyrene)s, poly(styrene sulfonate)s, and copolymers thereof, such as styrene/butyl methacrylate copolymer, styrene/acrylonitrile copolymer, styrene/allyl alcohol copolymer, and styrene/maleic anhydride copolymer; poly(vinylpyrrolidone)s; poly(vinyl acetate); polyacetals such as poly(vinyl butyral); cellulosics, including hydroxyalkyl celluloses such as hydroxypropyl cellulose, hydroxyalkyl alkylcelluloses such as hydroxypropyl methylcellulose, and the like, as well as partially or completely esterified analogs thereof; and combinations or copolymers thereof.

In some embodiments, the binder material is or includes polymethylmethacrylate (PMMA), which can be of various molecular weights, such as in the range of about 5,000 to about 2,000,000. For ink-jet printing of the ink composition, the binder material may include PMMA having exemplary molecular weights in the range of about 5,000 to about 100,000, about 10,000 to about 40,000, and so on. For screen printing of the ink composition, the binder material may include PMMA in the range of about 30,000 to about 2,000,000, about 100,000 to about 1,000,000, and the like.

The optional oligomeric/polymeric binder/viscosity enhancer(s), as described herein, may be present in any amount sufficient to allow satisfactory fabrication of the content access layer by techniques known in the art for depositing materials onto substrates. In one embodiment where the ink composition is spin-coated to form the content access layer, the ink composition can contain one or more oligomeric/polymeric binder/viscosity enhancers in a total amount ranging from about 3% to about 35% by weight, preferably from about 5% to about 25% by weight, for example from about 10% to about 20% by weight. In another embodiment where the ink composition is deposited by print-on-demand techniques such as ink-jet printing to form the content access layer, the ink composition can contain one or more oligomeric/polymeric binder/viscosity enhancers in a total amount ranging from about 0.5% to about 10% by weight, preferably from about 1% to about 5% by weight.

As with the optional oligomeric/polymeric binder/viscosity enhancer(s) and the optional bleaching accelerants, the optional diluent(s), as described herein, can advantageously be tailored to the particular ink composition used in the content access layer. Preferably, the diluent(s) used should not include those that significantly detrimentally affect the optical performance characteristics and/or the physico-chemical performance characteristics (e.g., uniformity, mechanical strength, etc.) of the optically transparent layer(s). As used herein, the phrase “significantly detrimentally affect,” in reference to a property, means negatively affect (in this case, decrease) that property by at least 20%, preferably by at least 15%, more preferably by at least 10%. Examples of useful diluents can include, but are not limited to, organic ethers such as propylene glycol monomethyl ether (PGME; e.g., sold under the tradename Dowanol® PM, commercially available from Dow), diethylene glycol monomethyl ether (DGME), diethylene glycol monobutyl ether (DGBE), and the like; hydroxy-functional solvents such as glycerol, ethanol, methanol, alkylene glycols such as ethylene glycol, propylene glycol, and polyethylene glycol, 1,2-hexanediol, 1,6-hexanediol, isopropanol, diacetone alcohol, and the like; dialkyl ketones such as acetone, methyl ethyl ketone, and the like; aromatics such as toluene, xylene, mesitylene, and the like; alkyl halides such as chloroform, bromoform, methylene chloride, methylene bromide, trichloromethane, and the like; and combinations thereof.

The optional diluent(s), as described herein, can be present in any amount sufficient to allow fabrication of the content access layer by techniques known in the art for depositing materials onto substrates. In one embodiment, the ink composition contains one or more diluents in a total amount ranging from about 30% to about 98% by weight, from about 45% to about 95% by weight, for example from about 70% to about 90% by weight.

The ink composition may also contain other additives to aid in processing. These may include dispersants such as Disperbyk™ (BYK-Chemi, USA), surfactants such as Surfynol™ (Air Products, USA), leveling agents, anti-foaming agents, viscosity modifiers, and the like, to improve various properties of the ink composition.

The amounts of the dye compound(s) and optional bleaching accelerant(s) can be greater, and the amount of optional diluent(s) can be lower, than the embodiments described above. For example, an increase in the amount of dye compound(s) to up to about 20% by weight or higher can become beneficial, especially when a high opacity is desired in the content access layer and/or when the number of exposures to the data reader system before the appropriate change in optical properties can be observed is desired to be more than the relatively small number discussed above.

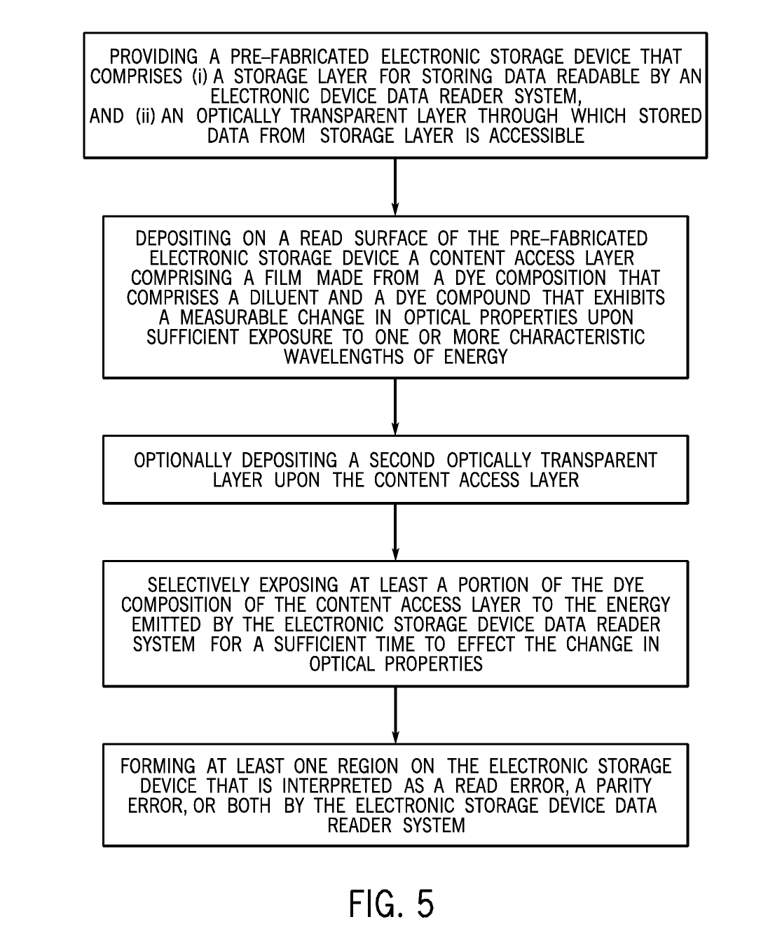

Another aspect of the technique relates to a method of fabricating a limited-use optical storage device, as described herein, for use with an optical storage device data reader system. In one embodiment, the method can include, but is not limited to, depositing on a read surface of pre-fabricated optical storage device 30, content access layer 14, as described herein, and optionally optically transparent (and protective) layer 12 upon content access layer 14. See, e.g., the flow chart of FIG. 5. The method also includes selectively exposing at least a portion of the ink composition of content access layer 14 to incident energy having one or more pre-selected wavelengths/frequencies for a sufficient time and at a sufficient intensity to effect a change in optical properties of the dye compound(s) in the exposed portion of the ink composition. This process can form at least one region on optical storage device 10 that is interpreted as a parity error and/or a read error by the optical storage device data reader system. The step of depositing content access layer 14 can be performed such that content access layer 14 is positioned between the optical storage device data reader system and storage layer 18 of pre-fabricated optical storage device 30 from which data is to be accessed, and typically proximal to another optically transparent layer 12, e.g., made from a polycarbonate material.

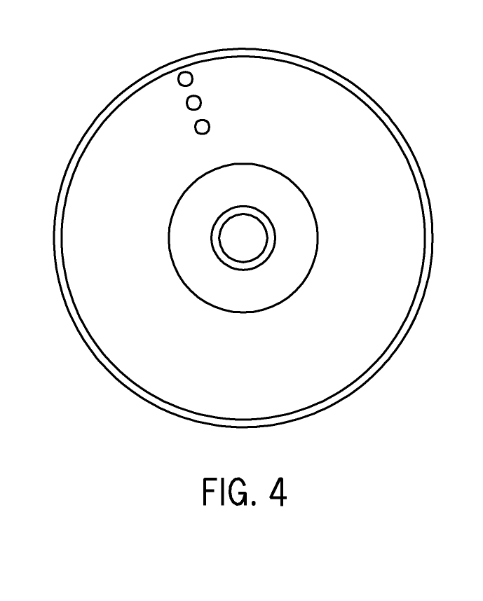

In an example, the selectively exposing step is accomplished by exposing content access layer 14 of optical storage device 10 to an energy source using a photomask tailored to obscure from the energy source the portion(s) of content access layer 14 where a change in optical properties are not desired and to allow exposure from the energy source to the portion(s) of content access layer 14 where a change in optical properties is desired. See, e.g., the photobleaching of all but three circular spots on the content access layer, as shown in FIG. 4. In such embodiments, the shape of the photomask can facilitate optical property changes in regions of any desired shape, e.g., circles, squares, astroids, rectangles, trapezoids, arcs, wedges, triangles, Reuleaux triangles, deltoids, cardioids, folia, nephroids, sectors, annuli, parallelograms, and the like, and combinations thereof.

The depositing of content access layer 14 (and optional second transparent/protective layer 12) is(are) achieved using a deposition process (or processes) that results in substantially no additional read errors. The term “additional read errors” means errors arising from the deposition process(es), which expressly does not include any read errors that were present, if any, in original pre-fabricated optical storage device 30 or that would have been present in the layers characteristic of a pre-fabricated optical storage device, e.g., without content access layer 14 and without optional second optically transparent layer 12, if present).

The depositing of content access layer 14 may be accomplished by a technique other than an ink-jet printing technique. On the other hand, the depositing of content access layer 14 may be achieved by spin coating the ink composition onto a read surface of pre-fabricated optical storage device 30. In another example, the depositing of content access layer 14 is achieved by spin coating the ink composition onto the entire read surface of pre-fabricated optical storage device 30.

In embodiments where the depositing of content access layer 14 is achieved by spin coating, a decreased amount of read errors (after bleaching) were observed for increased concentrations of dye compound(s), for spinning speeds that were relatively high, and for content access layer thicknesses that were relatively small (thin). Without being bound by theory, it is believed that increased dye compound concentration, increased spin speeds, and decreased layer thicknesses all positively affect the uniformity of the content access layer itself and/or of the dye compound dispersion amongst the content access layer.

If necessary or desired, after depositing content access layer 14 (but before depositing optional second transparent/protective layer 12, if present), any excess ink composition may be rinsed away with an appropriate solvent, e.g., the diluent(s) used in the ink composition, as described herein.

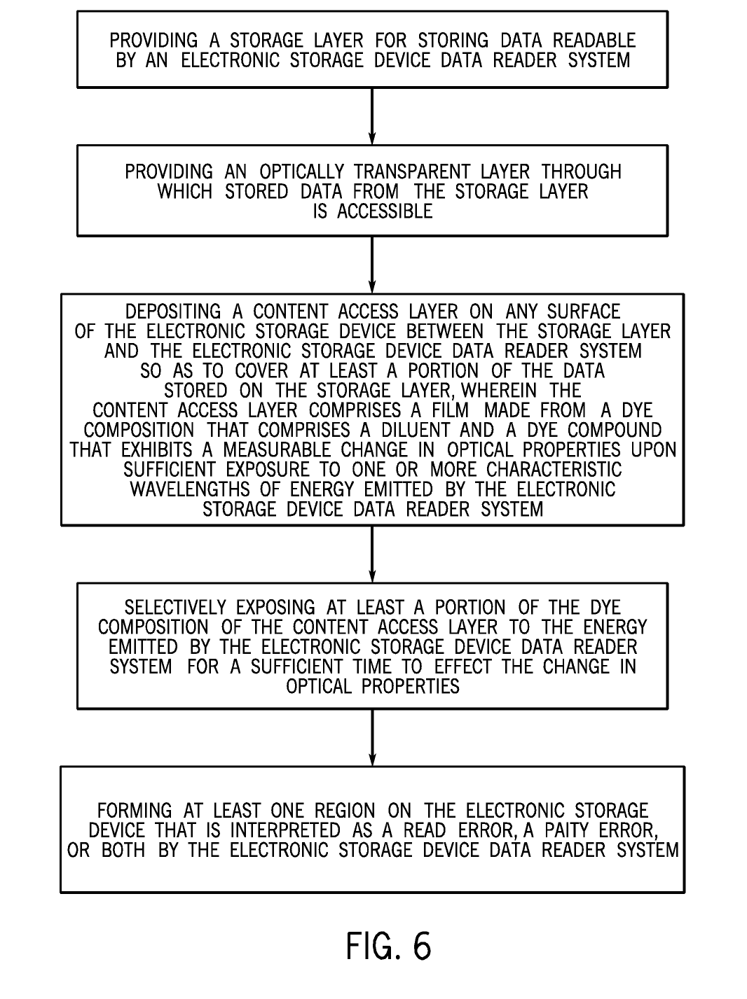

In another embodiment, the method can include, but is not limited to, the steps of: (i) providing optical storage device 30; (ii) depositing on optical storage device 30 content access layer 14, as described herein, between storage layer 18 and optically transparent layer 12 or 16; (iii) selectively exposing at least a portion of the ink composition of content access layer 14 to incident energy having one or more pre-selected wavelengths/frequencies for a sufficient time and at a sufficient intensity to effect a change in optical properties of the dye compound(s) in the exposed portion of the ink composition, and (iv) forming at least one region on optical storage device 30 that is interpreted as a read error and/or a parity error by the optical storage device data reader system. See, e.g., the flow chart of FIG. 6.

An example of a depositing process involves spin coating the ink compositions of content access layer 14 over an entire read surface of optical storage device 30. When the ink composition is originally colored and/or relatively opaque to a given wavelength of incident energy, subsequently one or more regions/spots are created by using a photomask to selectively bleach away the remainder of the color and/or opacity of the ink composition. In this embodiment, the one or more spots can cover specific regions of the storage layer. After one exposure or a predetermined number of (e.g., less than about 5) exposures to the energy emitted by the optical storage device data system reader, the transmissivity of content access layer 14 to the emitted energy should increase, allowing access to data on those specific regions of storage layer 18 that were previously inaccessible.

There are several ways in which to make data stored on storage layer 18 of limited-use content. In one embodiment, the one or more spots created can correspond to the area(s) of storage layer 18 on which one or more menus are stored. Upon a first or small number of initial plays of a DVD, for example, the menu(s) may be unreadable, causing the data reader system to indicate a read error, at which point the limited-use content, such as a trailer and/or advertisement, can be played without any choices by the user. However, after the initial number of plays of the DVD, when sufficient bleaching of the spots occurs, the menu(s) can be read and may give a user the ability to see the limited-use content again, if desired, or to skip the limited-use content entirely, if desired.

Alternately, the one or more spots created can be disposed over some specific area(s) of storage layer 18 that does not directly correspond to a menu or to any limited-use content. In this latter embodiment, upon noting a read error resulting from the unbleached ink composition, the DVD reader may be directed to a first portion of storage layer 18 on which the limited-use content data is stored. However, after the initial number of plays of the DVD, when sufficient bleaching of the spots occurs, the DVD reader may be directed to a second portion of storage layer 18, thus bypassing the limited-use content data. Thus, such a DVD may contain logic for detecting a change of optical state (or a change in read/parity error status) of the DVD and for directing the data reader system to the second portion of storage layer 18. A description of such logic, and a DVD containing such logic, can be found, for example, in U.S. Pat. No. 7,127,066.

In the following examples, ink compositions were applied to the read-side (laser-incident surface, represented, for example, by the bottom of layer 16 in FIG. 1) of DVDs to form respective content access layers 14. Content access layers 14 contained dye compounds/compositions that were found to be more sensitive (faster rate of photobleaching) than those described in the prior art, e.g., the phthalocyanines or naphtholocyanines disclosed in U.S. Pat. No. 7,127,066, which is incorporated by reference herein in its entirety.

Furthermore, the ink compositions were applied by various methods. In a preferred embodiment, the entire read surface of the DVD is spin-coated with the ink composition. Then regions of one or more spots are created by bleaching away undesired regions of dye with use of a photomask. This creates a variation of reflectivity in the coating while maintaining a uniform coating on the disc. It has been discovered that other deposition methods, e.g., ink-jet printing, screen printing, and pad printing are suitable methods for applying the ink to a substrate.

It should be noted that coating layers containing certain thiazines such as methylene blue, when exposed to light in the presence of organic amines such as triethanolamine, will bleach (turn from relatively opaque/colored to relatively transparent/colorless) relatively rapidly. However, upon removal of such a thiazine coating composition from the light source, the color of the dye will return (it will revert back to approximately its prior opacity/blue color) over a period of hours to days. This bleaching reversibility is undesirable in some embodiments. In contrast, it has also been discovered that, under similar conditions, cyanine dyes such as HNu 640 are not similarly reversibly bleachable. In some embodiments, the method of accelerated development of photosensitive materials disclosed in U.S. Patent Application Publication No. 2004/0152127 A1, which is incorporated by reference herein in its entirety, can be used to evaluate ink compositions for content access layers, as described herein.

### Exemplary Data and Analysis

The following examples, exemplary data, and associated discussion are set forth to provide those of ordinary skill in the art with a detailed description of how the techniques claimed herein are evaluated, and are not intended to limit the scope of what the inventors regard as their invention.

As discussed, the present technique may relate to a limited-play optical article, such as a 1-play DVD. With this and other technologies, the present ink formulations may incorporate a photobleachable dye system dissolved or dispersed in a polymer matrix. The ink is printed in a spot or in a pattern of spots on the data side of the optical article, such as a DVD. When the DVD is played, the ink spots block the player's laser and prevent the player from reading the data underneath the ink spots. If the data underneath the ink spots can not be read, the DVD may be authored to play a certain set of content and to also position the laser so that is exposes the ink spots to 650 nm light. This light exposure initiates a chemical reaction in the ink, which bleaches the ink. On subsequent plays of the DVD, the bleached ink no longer prevents the DVD laser from reading the data that is positioned under the ink spots. In other words, after bleaching, the data is “uncovered” and the DVD is authored to skip a certain set of video content.

An aspect of present ink formulations may be a photobleachable ink that has the adequate sensitivity to bleach when exposed to 650 nm light inside a DVD player or DVD drive. The speed or rate at which the 1-play ink bleached may be dependent on the degree of drying (time and temperature) used to remove residual solvent from the ink after the ink is deposited on a DVD substrate.

Exemplary ink formulations of the present technique may include a polymethine (e.g., cyanine) dye, a bleaching accelerant (e.g., borate), and an ionic liquid plasticizer. Optionally the bleaching accelerant and ionic liquid plasticizer may be combined together as an ion pair in the same compound. (e.g. 1-methyl-3-octylimidazolium triphenylbutylborate). The borate or borate anion may act as a bleaching accelerant. In general, the bleaching accelerant may be an electron donating agent. The formulations may also include a polymer as a binder material. The formulations may also include an ionic liquid plasticizer to increase the bleach rate. Lastly, the formulations may typically include a solvent. In addition to a polymer and solvent exemplary formulation combinations may include:
(1) cyanine dye+ionic liquid plasticizer;
(2) cyanine dye+borate+ionic liquid plasticizer;
(3) cyanine dye+borate+ionic liquid plasticizer+complex of ionic liquid plasticizer with borate;
(4) cyanine+borate+complex of ionic liquid plasticizer with borate;
(5) cyanine+complex of ionic liquid plasticizer with borate;
(6) complex of cyanine dye ion paired with borate+ionic liquid plasticizer;
(7) complex of cyanine dye ion paired with borate+borate+ionic liquid plasticizer;
(8) complex of cyanine dye ion paired with borate+borate+ionic liquid plasticizer+complex of ionic liquid plasticizer with borate;
(9) complex of cyanine dye ion paired with borate+borate+complex of ionic liquid plasticizer with borate;
(10) complex of cyanine dye ion paired with borate+complex of ionic liquid plasticizer with borate;
(11) cyanine+complex of cyanine dye ion paired with borate+ionic liquid plasticizer;
(12) cyanine+complex of cyanine dye ion paired with borate+borate+ionic liquid plasticizer;
(13) cyanine+complex of cyanine dye ion paired with borate+borate+ionic liquid plasticizer+complex of ionic liquid plasticizer with borate;
(14) cyanine+complex of cyanine dye ion paired with borate+borate+complex of ionic liquid plasticizer with borate; and
(15) cyanine+complex of cyanine dye ion paired with borate+complex of ionic liquid plasticizer with borate.

The inks were formulated using cyanine dye H-Nu 640, photo-bleaching accelerant Borate V (butyrylcholine triphenyl-n-butyl borate), polymer binder, either PMMA or Polypyrrolidone (PVPD). H-Nu 640 and Borate V were obtained from SPECTRA GROUP LIMITED, INC (Millbury, Ohio). The make up solvent is Dowanol DPM & Diacetone Alcohol (1:1 v/v). Table 1 disclosed ionic liquids used in this inventions. The relative bleach rate of the ink calculated by comparing to control example # 1 (Table 2). Tables 2, 3 and 4 show the various ink formulations and the relative bleach rate. It should be noted that in these examples, the percent reflectivity was measured using an Ocean Optics UV-vis spectrophotometer employing a fiber-optic reflectance probe oriented normal to the optical storage medium. Percent reflectance is the measured value of light reflected off of optical storage medium according to Annex D in ECMA-267 specifications for DVD-Read-Only-Disk.

In this example, it was demonstrated that ionic liquid C8-IM-Borate has the best compatibility with the ink formation, good bleach rate compared to control (6 to 12×). Inks with C8-IM-Borate maintain bleach rate after thermal aging or aging in humidity chamber (example # 17, 20 & 23). Furthermore, when ionic liquid containing a triphenylbutylborate anion, such as C8-IM-Borate, is used no photo-bleaching accelerant (e.g., Borate V) is generally needed, as C8-IM-Borate acts as photo-bleaching accelerant also (example # 17, 20, 23, 34, 35 & 36). In contrast, DOP plasticized ink has good initial relative bleach rate (14×) but drop to the same bleach rate as control after aging in 60° C. oven for 29 hours (example # 3, 4 & 5).

TABLE 1
Abbreviations for Ionic Liquid Plasticizers

| | | Anion X⁻ | | | | |
|---|---|---|---|---|---|---|
| | | | | | | (V) |
| | | | | | | Triphenylbutylborate |
| 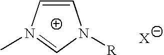 | | (I) Br⁻ | (II) BF₄⁻ | (III) PF₆⁻ | (IV) Lactate₋ | 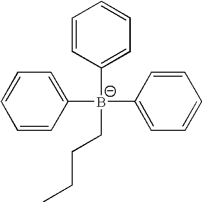 |
| Alkyl | C₄H₉ | C₄-IM-Br | C₄-IM-BF₄ | C₄-IM-PF₆ | C₄-IM-Lactate | C₄-IM-Borate |
| group R | C₆H₁₃ | C₆-IM-Br | C₆-IM-BF₄ | C₆-IM-PF₆ | C₆-IM-Lactate | C₆-IM-Borate |
| | C₈H₁₇ | C₈-IM-Br | C₈-IM-BF₄ | C₈-IM-PF₆ | C₈-IM-Lactate | C₈-IM-Borate |

For Table 1, in column I, the compounds are 1-methyl-3-butyl bromide, 1-methyl-3-hexyl bromide, and 1-methyl-3-octyl bromide. In column II, the compounds are 1-methyl-3-butyl tetrafluoro borate, 1-methyl-3-hexyl tetrafluoro borate, and 1-methyl-3-octyl tetrafluoro borate. In column III, the compounds are 1-methyl-3-butyl hexylfluoro borate, 1-methyl-3-hexyl hexylfluoro borate, and 1-methyl-3-octyl hexylfluoro borate. In column IV, the compounds are 1-methyl-3-butyl lactate, 1-methyl-3-hexyl lactate, and 1-methyl-3-octyl lactate. In column V, the compounds are 1-methyl-3-butylimidazoliumtriphenylbutyl borate, 1-methyl-3-hexylimidazoliumtriphenylbutyl borate, 1-methyl-3-octylimidazoliumtriphenylbutyl borate,

TABLE 2
Bleach Rates of Inks Plasticized with DOP

| | Wt % of Dye | wt % of | Polymer | | wt % of | Relative | Aging Temp | Aging Relative | Aging time |
|---|---|---|---|---|---|---|---|---|---|
| Example # | H-NU640 | Borate V | Binder/wt % | Plasticizer | Plasticizer | Rate | (deg C.) | Humidity (%) | (h) |
| 1 | 1.2 | 2.6 | PMMA/5 wt % | None | 0.0 | 1 | none | uncontrolled | none |
| 2 | 1.2 | 2.6 | PMMA/5 wt % | None | 0.0 | 1 | 25 | uncontrolled | 96 |
| 3 | 1.2 | 2.6 | PMMA/5 wt % | DOP | 7.5 | 14 | none | uncontrolled | none |
| 4 | 1.2 | 2.6 | PMMA/5 wt % | DOP | 7.5 | 10 | 25 | uncontrolled | 96 |
| 5 | 1.2 | 2.6 | PMMA/5 wt % | DOP | 7.5 | 1 | 60 | uncontrolled | 29 |

TABLE 3
Bleach Rates of Inks Plasticized with Ionic Liquids using PMMA as Binder

| | Wt % of Dye | wt % of | Polymer | | wt % of | Relative | Aging Temp | Aging Relative | Aging time |
|---|---|---|---|---|---|---|---|---|---|
| Example # | H-NU640 | Borate V | Binder/wt % | Plasticizer | Plasticizer | Rate | (deg C.) | Humidity (%) | (h) |
| 7 | 1.2 | 2.6 | PMMA/5 wt % | C4-IM-Lactate | 5.0 | NA¹ | none | uncontrolled | none |
| 8 | 1.2 | 2.6 | PMMA/5 wt % | C4-IM-Lactate | 1.2 | NA¹ | none | uncontrolled | none |
| 9 | 1.2 | 2.6 | PMMA/5 wt % | C4-IM-PF6 | 5.0 | 3 | none | uncontrolled | none |
| 10 | 1.2 | 2.6 | PMMA/5 wt % | C4-IM-PF6 | 1.2 | 3 | none | uncontrolled | none |
| 11 | 1.2 | 2.6 | PMMA/5 wt % | C6-IM-PF6 | 5.0 | 4 | none | uncontrolled | none |
| 12 | 1.2 | 2.6 | PMMA/5 wt % | C6-IM-PF6 | 1.2 | 4 | none | uncontrolled | none |
| 13 | 1.2 | 2.6 | PMMA/5 wt % | C8-IM-PF6 | 5.0 | 2 | none | uncontrolled | none |
| 14 | 1.2 | 2.6 | PMMA/5 wt % | C8-IM-PF6 | 1.2 | 3 | none | uncontrolled | none |
| 15 | 0.7 | 2.6 | PMMA/4 wt % | C8-IM-Br | 6.0 | 9 | none | uncontrolled | none |
| 16 | 0.7 | 2.6 | PMMA/4 wt % | C8-IM-PF6 | 6.0 | 7 | none | uncontrolled | none |
| 17 | 0.7 | 0.0 | PMMA/4 wt % | C8-IM-Borate | 6.0 | 8 | none | uncontrolled | none |
| 18 | 0.7 | 2.6 | PMMA/4 wt % | C8-IM-Br | 6.0 | NA¹ | 60 | uncontrolled | 24 |
| 19 | 0.7 | 2.6 | PMMA/4 wt % | C8-IM-PF6 | 6.0 | NA¹ | 60 | uncontrolled | 24 |
| 20 | 0.7 | 0.0 | PMMA/4 wt % | C8-IM-Borate | 6.0 | 8 | 60 | uncontrolled | 24 |
| 21 | 0.7 | 2.6 | PMMA/4 wt % | C8-IM-Br | 6.0 | NA¹ | 60 | uncontrolled | 24 |
| 22 | 0.7 | 2.6 | PMMA/4 wt % | C8-IM-PF6 | 6.0 | NA¹ | 60 | uncontrolled | 24 |
| 23 | 0.7 | 0.0 | PMMA/4 wt % | C8-IM-Borate | 6.0 | 8 | 85 | 85 | 24 |

¹Sample phase separated

TABLE 4
Bleach Rates of Inks Plasticized with Ionic Liquids using PVPD as Binder

| | Wt % of Dye | wt % of | Polymer | | wt % of | Relative | Aging Temp | Aging Relative | Aging time |
|---|---|---|---|---|---|---|---|---|---|
| Example # | H-NU640 | Borate V | Binder/wt % | Plasticizer | Plasticizer | Rate | (deg C.) | Humidity (%) | (h) |
| 24 | 1.2 | 2.6 | PVPD/4 wt % | None | 0.0 | 2 | none | uncontrolled | none |
| 25 | 1.2 | 2.6 | PVPD/4 wt % | None | 0.0 | 1 | 60 | uncontrolled | 21 |
| 26 | 1.2 | 2.6 | PVPD/4 wt % | C4-IM-BF4 | 4.6 | 3 | none | uncontrolled | none |
| 27 | 1.2 | 2.6 | PVPD/4 wt % | C4-IM-BF4 | 4.6 | 3 | none | uncontrolled | none |
| 28 | 1.2 | 2.6 | PVPD/4 wt % | C4-IM-BF4 | 4.6 | 3 | 60 | uncontrolled | 28 |
| 30 | 1.2 | 2.6 | PVPD/4 wt % | C8-IM-Br | 4.6 | 7 | none | uncontrolled | none |
| 31 | 1.2 | 2.6 | PVPD/4 wt % | C8-IM-Br | 4.6 | 6 | 60 | uncontrolled | 4 |
| 32 | 1.2 | 2.6 | PVPD/4 wt % | C8-IM-Br | 4.6 | 6 | 60 | uncontrolled | 28 |
| 33 | 1.2 | 2.6 | PVPD/4 wt % | C8-IM-Borate | 5.5 | 7 | none | uncontrolled | none |
| 34 | 1.2 | 0 | PVPD/4 wt % | C8-IM-Borate | 8.5 | 7 | none | uncontrolled | none |
| 35 | 0.64 | 0 | PVPD/4 wt % | C8-IM-Borate | 7.8 | 12 | none | uncontrolled | none |
| 36 | 0.64 | 0 | PVPD/4 wt % | C8-IM-Borate | 7.8 | 12 | 60 | uncontrolled | 29 |

The technique may also consist of formulations of photo-bleachable ink containing dialkyldiphenylborate. The use of dialkyldiphenylborate increases the speed with which the inks photo-bleach when exposed to 630-660 nm lights. Results in Table 5 shows that the ink formulation using C8-IM-dibutyl borate has 60-time bleach rate to standard ink formulation #1.

TABLE 5
Bleach Rate Comparison of Inks

| | Ink 1 | Ink 2 | Ink 3 |
|---|---|---|---|
| Dye H-Nu640 (wt %) | 1.2 | 1.2 | 1.2 |
| PMMA (Mw = 37 k) wt % | 5.0 | 5.0 | 5.0 |
| Borate V (wt %) | 2.6 | | |
| C8-IM-Butyltriphenyl Borate (wt %) | | 7.5 | |
| C8-IM-Dibutyldihenyl Borate (wt %) | | | 7.5 |
| Dowanol DPM & Diacetone Alcohol (1:1 | 91.2 | 86.3 | 86.3 |
| v/v). wt % | | | |
| Relative bleach rate | 1 | 6 | 60 |

Structures are provided below:

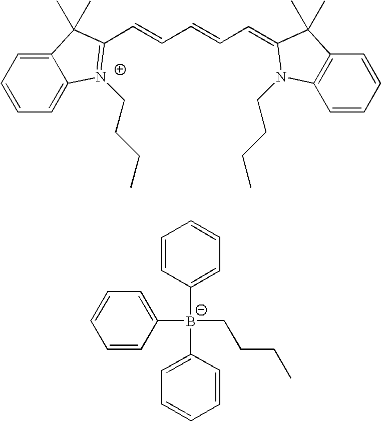

### Cyanine Dye H-Nu 640

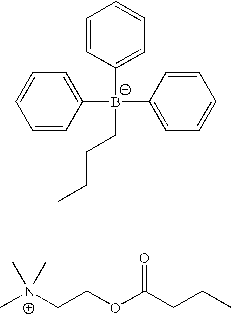

Photo-bleaching accelerant Borate V

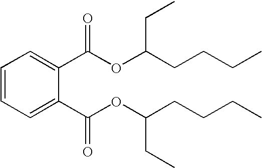

Dioctyl phthalate (DOP)

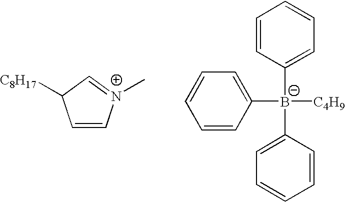

Photo-bleaching accelerant C8-IM-Butyltriphenyl

### Borate

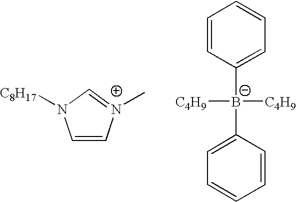

Photo-bleaching accelerant C8-IM-Dibutydiphenyl
Borate

1. A photobleachable ink composition comprising:
at least one light-sensitive optical-state change material;
at least one bleaching accelerant;
at least one ionic liquid plasticizer;
at least one solvent;
and at least one binder material; wherein the ink composition has a viscosity between about 0.1 centipoise and about 10,000 centipoise, and a maximum optical absorbance in a range from about 200 nanometers to about 800 nanometers; and wherein said ink composition is capable of change from a first optical state to a second optical state upon exposure to light.

2. The composition of claim 1, wherein the bleaching accelerant comprises alkylltriphenyl borate anion or dialkylldiphenyl borate anion, or a combination thereof, where the alkyl chain length is a linear or branched chain of 1-16 carbons or a combination thereof.

3. The composition of claim 1, wherein the bleaching accelerant comprises the ionic liquid plasticizer.

4. The composition of claim 1, wherein the optical-state change material comprises a polymethine dye.

5. The composition of claim 1, wherein the bleaching accelerant comprises any combination of one cation and one anion from the following list:
Cations: 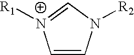 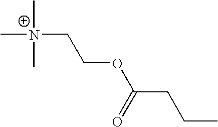
Anions

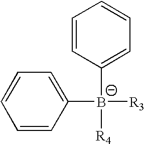

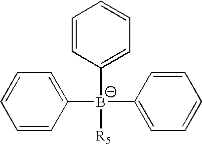

6. The composition of claim 1, wherein a change in optical absorbance from the first optical state to the second optical state is greater than 15 percent.

7. The composition of claim 5, wherein the ionic liquid plasticizer comprises an imidazolium salt, quaternary ammonium salt, phosphonium salt, pyrazolium salt, pyridinium salt, sulfonium salt, piperidinium salt, and morpholinium salt or any combination thereof, and increases the bleach rate of the photobleachable ink composition.

8. A photosensitive ink composition, comprising:
at least one photosensitive optical-state change material comprising a dye;
at least one additive for accelerating bleaching;
at least one ionic liquid plasticizer;
at least one solvent; and
at least one binder material,
wherein the phtosensitive ink composition comprises a viscosity between about 0.1 centipoise and about 10,000 centipoise, and a maximum optical absorbance in a range from about 200 nanometers to about 800 nanometers, and wherein the phtosensitive ink composition is capable of transforming from a first optical state to a second optical state upon exposure to an optical stimulus.

9. The composition of claim 8, wherein the dye comprises a polymethine dye.

10. The composition of claim 8, wherein the additive for accelerating bleaching comprises an electronic donating agent

11. The composition of claim 8, wherein the at least one solvent comprises a glycol ether solvent, an aromatic hydrocarbon solvent containing at least 7 carbon atoms, an aliphatic hydrocarbon solvent containing at least 6 carbon atoms, a halogenated solvent, an amine based solvent, an amide based solvent, a oxygenated hydrocarbon solvent, or any miscible combination thereof.

12. The composition of claim 8, wherein the binder material comprises a polymer, an oligomer, a polymeric precursor, or a polymerizable monomer, or any combination thereof.

13. The composition of claim 8, wherein the binder material comprises a polyolefin, a polyester, a polyamide, a polyacrylate, a polymethacrylate, polymethylmethacrylate (PMMA), a polyvinylchloride, a polycarbonate, a polysulfone, a polysiloxane, a polyetherimide, a polyetherketone, a copolymer thereof, or any combination thereof.

14. The composition of claim 8, wherein the photosensitive ink composition is transformed from the first optical state to the second optical state by exposure to a 650 nm laser in a DVD player.

15. The composition of claim 14, wherein exposure comprises exposure to a 650 nm laser of 1-50 mW in a DVD player for less than 300 seconds.

16. The composition of claim 8, wherein the difference in optical absorbance of the photosensitive ink composition between the first optical state and the second optical state is at least 10 percent.

17. A light-sensitive coating deposited using a light-sensitive ink composition, wherein the coating comprises:
at least one light-sensitive optical-state change material;
at least one bleaching agent;
at least one ionic liquid plasticzer; and
at least one binder material, wherein the light-sensitive coating is essentially free of solvent and has a maximum optical absorbance in a range from about 200 nanometers to about 800 nanometers, and wherein the light-sensitive coating is capable of transforming from a first optical state to a second optical state upon exposure to light.

18. The coating of claim 17, wherein the photosensitive optical-state change material comprises at least one polymethine dye.

19. The coating of claim 17, wherein the ionic liquid plasticizer comprises an imidazolium salt, quaternary ammonium salt, phosphonium salt, pyrazolium salt, pyridinium salt, sulfonium salt, piperidinium salt, and morpholinium salt or a combination of two or more, and wherein the difference in optical absorbance of the photosensitive coating composition between the first optical state and the second optical state is at least 10 percent.

20. The coating of claim 17, wherein reflectivity of the light sensitive coating changes by less than 5% after exposure of the light sensitive coating to 60° C. for 24 hours.

21. The coating of claim 17, wherein the bleaching agent comprises an electron donating agent.

22. The coating of claim 17, wherein the bleaching agent comprises an imidazolium borate.

23. An article comprising a photosensitive coating composition deposited in or deposited on the article, wherein the photosensitive coating composition comprises at least one photosensitive optical-state change material, at least one additive for accelerating the bleaching, at least one ionic liquid plasticzer, and at least one binder material, wherein said photosensitive coating composition is essentially free of solvent, wherein said photosensitive coating composition has an optical absorbance in a range from about 200 nanometers to about 800 nanometers, and wherein said photosensitive coating is capable of transforming from a first optical state to a second optical state upon exposure to a light stimulus.

24. The article of claim 23, wherein the optical article comprises a CD, a DVD, a HD-DVD, a blu-ray disc, a near field optical storage disc, or a holographic storage medium.

25. The optical article of claim 23, wherein the composition is deposited in a discrete area of the optical article, a continuous layer extending across a portion of the optical article, or a patterned layer extending across a portion of the optical article.

26. The article of claim 23, wherein the ionic liquid plasticizer comprises an imidazolium, quaternary ammonium, phosphonium, pyrazolium, pyridinium, sulfonium, piperidinium, or morpholinium cation in combination with a diphenyldialkylborate anion, where the alkyl groups are independently linear or branched chains of 1 to 16 carbons as a combined photo-bleaching agent and ionic liquid.

27. The article of claim 23, wherein the ionic liquid plasticizer comprises an imidazolium, quaternary ammonium, phosphonium, pyrazolium, pyridinium, sulfonium, piperidinium, or morpholinium cation in combination with a triphenylalkylborate anion, where the alkyl groups are independently linear or branched chains of 1 to 16 carbon atoms as a combined photo-bleaching agent and ionic liquid.

28. An optical storage device on which at least some limited-use data is stored, comprising:
a storage layer for storing data readable by an optical storage device data reader system;
a content access layer covering at least a portion of the data stored on the storage layer and comprising an ink composition comprising a dye compound and an ionic liquid plasticzer, wherein the ink composition exhibits a measurable change in optical properties in less than about 10 seconds of exposure to a light source emitting wavelengths from about 635 nm to about 650 nm at an intensity from about 1 mW to about 50 mW; and
an optically transparent layer through which stored data from the storage layer is accessible.

29. An optical storage device, on which at least some limited-use data is stored, comprising:
a storage layer for storing data readable by an optical storage device data reader system;
a content access layer covering at least a portion of the data stored on the storage layer, wherein the content access layer comprises a dye, a bleaching accelerant, and an ionic liquid plasticzer, wherein the dye exhibits a measurable change in optical properties upon sufficient exposure to one or more characteristic wavelengths of energy; and
an optically transparent layer through which stored data from the storage layer is accessible.

30. The optical storage device of claim 29, wherein the ionic liquid plasticizer comprises an imidazolium, quaternary ammonium, phosphonium, pyrazolium, pyridinium, sulfonium, piperidinium, or morpholinium cation in combination with a diphenyldialkylborate anion or a triphenylalkylborate anion, or any combination thereof, where the alkyl groups are independently linear or branched chains of 1 to 16 carbons as a combined photo-bleaching agent and ionic liquid.

31. The optical storage device of claim 29, wherein the ionic liquid plasticizer comprises 1-methyl-3-octyl imidazolium hexafluoophosphate, 1-methyl-3-ctylimidazoliumtetrafluoroborate, or 1-methyl-3-octylimidazoliumbromide, or any combination thereof.

32. The optical storage device of claim 29, wherein the bleaching accelerant comprises borate, borate salts, Borate V (butyrylcholine triphenyl-n-butyl borate), butyltriphenyl borate, or dibutyldiphenyl borate, or any combination thereof.

33. A method of fabricating a limited-use optical storage device, comprising:
depositing a photobleachable ink composition comprising at least one light-sensitive optical-state change material, at least one bleaching agent, at least one ionic liquid plasticzer, at least one solvent, and at least one binder material; wherein the ink composition has a viscosity between about 0.1 centipoise and about 10,000 centipoise, and a maximum optical absorbance in a range from about 200 nanometers to about 800 nanometers, and wherein the ink composition is capable of transforming from a first optical state to a second optical state upon exposure to light.

34. The method of claim 33, wherein the bleaching agent comprises butyltriphenyl borate anion, pentyltriphenylborate anion, dipentyldiphenylborate anion or dibutyldiphenyl borate anion, or a combination thereof.

35. The method of claim 33, wherein the optical-state change material comprises a polymethine dye.

36. The method of claim 33, wherein the ionic liquid plasticizer comprises the bleaching agent.

37. The composition of claim 33, wherein the binder material comprises polymethylmethacrylate (PMMA) having a molecular weight in the range of 5,000 to 2,000,000.

38. The method of claim 33, wherein the ionic liquid plasticizer comprises an imidazolium cation with a borate anion.

39. The method of claim 38, wherein the ionic liquid plasticizer comprises 1-methyl-3-octylimidazolium triphenylbutylborate or 1-methyl-3-octylimidazolium diphenyldipentylborate, or a combination thereof.

40. The method of claim 38, wherein the imidazolium cation comprises: 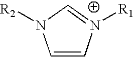
where R1 and R2 are independently hydrogen or linear or branched alkyl chains that contain from 1-16 carbons; and
wherein the borate anion comprises: 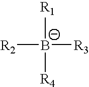
where R₁, R₂, R₃, and R₄ independently represent alkyl, aryl, alkaryl, allyl, aralkyl, alkenyl, alkynyl, silyl, alicyclic or saturate or unsaturated heterocyclic group or a combination thereof.

41. The method of claim 33, wherein the change in optical absorbance from the first optical state to the second optical state is greater than 15 percent.

42. The method of claim 41, wherein the change is substantially irreversible.

43. The method of claim 33, wherein the ionic liquid plasticizer increases a bleach rate of the photobleachable ink composition.

44. The method of claim 43, wherein the ionic liquid plasticizer substantially maintains the increase bleach rate over time.
